(19) United States
(12) Patent Application Publication
(10) Pub. No.: US 2019/0094456 A1
(43) Pub. Date: Mar. 28, 2019

(54) BACKLIGHT UNIT AND DISPLAY DEVICE INCLUDING THE SAME

(71) Applicant: Samsung Display Co., Ltd., Yongin-si (KR)

(72) Inventors: Jee Na LEE, Anyang-si (KR); Sang Woon JUNG, Seongnam-si (KR); Man Soo KIM, Asan-si (KR)

(21) Appl. No.: 16/106,755

(22) Filed: Aug. 21, 2018

(30) Foreign Application Priority Data
Sep. 22, 2017 (KR) 10-2017-0122233

(51) Int. Cl. F21V 8/00; G02F 1/1333; G02F 1/1368

(52) U.S. Cl. CPC G02B 6/0088; G02B 6/0055; G02B 6/0093; G02F 1/133308; G02F 1/133528; G02B 6/009; G02B 6/0085; G02F 2001/133317; G02F 1/1368

(57) ABSTRACT

A backlight unit and a display device are provided. The display device comprises: a display panel; and a backlight unit providing light to the display panel, wherein the backlight unit includes: a light emitting unit emitting light, a holder coupled with the light emitting unit and made of a metal material having rigidity, and a light guide plate coupled with the holder and guiding light emitted from the light emitting unit, and the light emitting unit and the light guide plate are integrated with each other by the holder.

### CROSS-REFERENCE TO RELATED APPLICATION

This application claims priority to and the benefit of Korean Patent Application No. 10-2017-0122233, filed on Sep. 22, 2017, in the Korean Intellectual Property Office, the entire content of which is herein incorporated by reference.

### BACKGROUND

### 1. Field

The present description relates to a backlight unit and a display device including the backlight unit.

### 2. Description of the Related Art

The importance of a display device has increased with the development of multimedia technology. Accordingly, various types of display devices such as a liquid crystal display (LCD) and an organic light-emitting display (OLED) have been developed.

For example, a liquid crystal display device includes a display panel including electric field generating electrodes (such as a pixel electrode and a common electrode) and a liquid crystal layer, and a backlight unit providing light to the display panel. In the liquid crystal display device, a voltage is applied to the electric field generating electrodes to rearrange liquid crystals, and thus the amount of light transmitting through the liquid crystal layer for each pixel is controlled, thereby realizing an image display.

Meanwhile, there is a recent need to have a display device that is large, light and thin.

### SUMMARY

In the case of a display device requiring a back light source such as a backlight unit, the thickness of the backlight unit is considerable. Therefore, a method of reducing the total thickness of the display device by reducing the thickness of the components in the backlight unit can be considered.

However, there is a trade-off between the thickness and durability of the backlight unit. If the backlight unit does not have sufficient durability, there may be a problem that the optical axis between the light emitting unit and light guide plate in the backlight unit is distorted, and also the durability and reliability of the backlight unit and the display quality of the display device may deteriorate, so that there is a limitation in reducing the thickness of the backlight unit. Such a problem can be further exacerbated as the display device becomes larger.

An aspect of an embodiment of the present invention is to provide a backlight unit, which can have excellent durability and reliability and be thin, through structural supplementation.

Another aspect of an embodiment of the present invention is to provide a display device, which can have excellent display quality and be thin, through structural supplementation.

However, aspects of embodiments of the present invention are not restricted to the one set forth herein. The above and other aspects of the present invention will become more apparent to one of ordinary skill in the art to which the present invention pertains by referencing the detailed description of the present invention given below.

According to an exemplary embodiment of the invention, there is provided a display device. The display device, comprises: a display panel; and a backlight unit providing light to the display panel, wherein the backlight unit includes: a light emitting unit emitting light, a holder coupled with the light emitting unit and made of a metal material having rigidity, and a light guide plate coupled with the holder and guiding light emitted from the light emitting unit, and the light emitting unit and the light guide plate are integrated with each other by the holder.

In an exemplary embodiment, the holder includes: a first coupling portion partially covering one surface of the light guide plate and coupled with the one surface, and a second coupling portion coupled with a light source circuit board of the light emitting unit, wherein a counter surface of the light guide plate, facing oppositely away from the one surface covered by the first coupling portion, is not covered by the holder.

In an exemplary embodiment, the backlight unit further includes a first junction member interposed between the first coupling portion of the holder and the light guide plate to couple the holder and the light guide plate. The one surface is a lower surface of the light guide plate and the counter surface is an upper surface of the light guide plate. The first coupling portion supports the lower surface of the light guide plate and is coupled with the lower surface thereof, and the upper surface of the light guide plate is not covered by the holder.

In an exemplary embodiment, the holder further covers a lower surface of the light source circuit board and one side surface of the light source circuit board.

In an exemplary embodiment, the backlight unit further includes: a reflective sheet disposed on the lower surface of the light guide plate and a cushion member interposed between the upper surface of the light guide plate and the display panel, and wherein the holder and the reflective sheet are disposed to be spaced apart from each other.

In an exemplary embodiment, the backlight unit further includes a first junction member interposed between the first coupling portion of the holder and the light guide plate to couple the holder and the light guide plate. The one surface is an upper surface of the light guide plate and the counter surface is a lower surface of the light guide plate. The first coupling portion is coupled with the upper surface of the light guide plate, and the lower surface of the light guide plate, is not covered by the holder.

In an exemplary embodiment, the holder further covers the upper surface of the light source circuit board and one side surface of the light source circuit board.

In an exemplary embodiment, the backlight unit further includes: a reflective sheet disposed on the lower surface of the light guide plate, and a cushion member interposed between the first coupling portion of the holder and the display panel. The reflective sheet partially overlaps the first junction member, and optical density of the cushion member is greater than optical density of the first junction member.

In an exemplary embodiment, the second coupling portion of the holder has a clip structure, and the light source circuit board of the light emitting unit is fitted into the clip structure.

In an exemplary embodiment, maximum thickness of the holder is about 0.3 millimeters (mm), or less, and rigidity of the holder is about 300 N/m, or more.

In an exemplary embodiment, the holder includes: a first coupling portion partially covering one surface of the light guide plate and coupled with the one surface thereof, a second coupling portion coupled with the light emitting unit, and a support portion providing a space for supporting the display panel and coupled with the display panel.

In an exemplary embodiment, the light guide plate has a light entrance surface facing the light emitting unit and a light exit surface facing the display panel. The backlight unit further includes a middle mold disposed at a counter surface of the light guide plate, the counter surface here facing oppositely away from the light entrance surface, the middle mold supporting the display panel and being coupled with the display panel.

In an exemplary embodiment, the backlight unit further includes: a first junction member interposed between the first coupling portion of the holder and the light guide plate to couple the holder and the light guide plate, and a second junction member interposed between the support portion of the holder and the display panel to couple the holder and the display panel or interposed between the middle mold and the display panel to couple the middle mold and the display panel, and wherein optical density of the second junction member is greater than optical density of the first junction member.

In an exemplary embodiment, the backlight unit further includes a bottom chassis having an inner space for accommodating the light emitting unit, the holder, the light guide plate, and the middle mold. The holder and the middle mold are disposed in the inner space of the bottom chassis, the holder and the bottom chassis are coupled with each other, and the middle mold and the bottom chassis are coupled with each other.

In an exemplary embodiment, the backlight unit further includes: a bottom chassis accommodating the light emitting unit, the holder and the middle mold; a reflective sheet interposed between a bottom surface of the bottom chassis and the light guide plate and in contact with the bottom chassis and the light guide plate; and an optical sheet disposed between the light guide plate and the display panel and in contact with the display panel and the light guide plate.

In an exemplary embodiment, the light emitting unit includes: a light source circuit board and a light source disposed on a mounting surface of the light source circuit board to emit light, and the mounting surface of the light source circuit board may be substantially in parallel with a light exit surface of the light source.

In an exemplary embodiment, wherein an upper surface of the light source circuit board is located at a higher level than an upper surface of the light guide plate, a lower surface of the light source circuit board is located at a lower level than a lower surface of the light guide plate, and the light exit surface of the light source is in contact with a light entrance surface of the light guide plate.

In an exemplary embodiment, the display panel includes a lower substrate, an upper substrate facing the lower substrate, and a liquid crystal layer interposed between the lower substrate and the upper substrate. A side surface of the upper substrate further protrudes out more than that of a side surface of the lower substrate, and the upper substrate may include a plurality of switching elements disposed for each pixel.

In an exemplary embodiment, the backlight unit further includes a second junction member interposed between the holder and the display panel to couple the holder and the display panel, and the second junction member is disposed to be in contact with the upper substrate.

According to an exemplary embodiment, there is provided a backlight unit. The backlight unit, comprises: a light emitting unit emitting light; a holder coupled with the light emitting unit and made of a metal material having rigidity; and a light guide plate coupled with the holder and guiding light emitted from the light emitting unit, wherein the light emitting unit and the light guide plate are integrated with each other by the holder.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exploded perspective view of a display device according to an embodiment of the present invention;

FIG. 2 is a sectional view taken along the line II-II′ of FIG. 1;

FIG. 3 is a sectional perspective view showing the vicinity of a holder of FIG. 2;

FIG. 4 is a sectional perspective view showing the vicinity of a middle mold of FIG. 2;

FIG. 5 is a sectional view of a display device according to another embodiment of the present invention;

FIG. 6 is a sectional perspective view showing the vicinity of a holder of FIG. 5;

FIG. 7 is a sectional view of a display device according to still another embodiment of the present invention; and

FIG. 8 is a sectional perspective view showing the vicinity of a holder of FIG. 7.

### DETAILED DESCRIPTION

Features of the invention and methods of accomplishing the same may be understood more readily by reference to the following detailed description of preferred embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an” and “the” are intended to include the plural forms as well, including “at least one,” unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. “At least one” is not to be construed as limiting “a” or “an.” “Or” means “and/or.” As used herein, the term “and/or” includes any and all combinations of one or more of the associated listed items.

Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

In the present specification, the first direction X means any one direction in the plane, the second direction Y means a direction intersecting the first direction X in the plane, and the third direction Z means a direction perpendicular to the plane.

Hereinafter, embodiments of the present invention will be described with reference to the attached drawings.

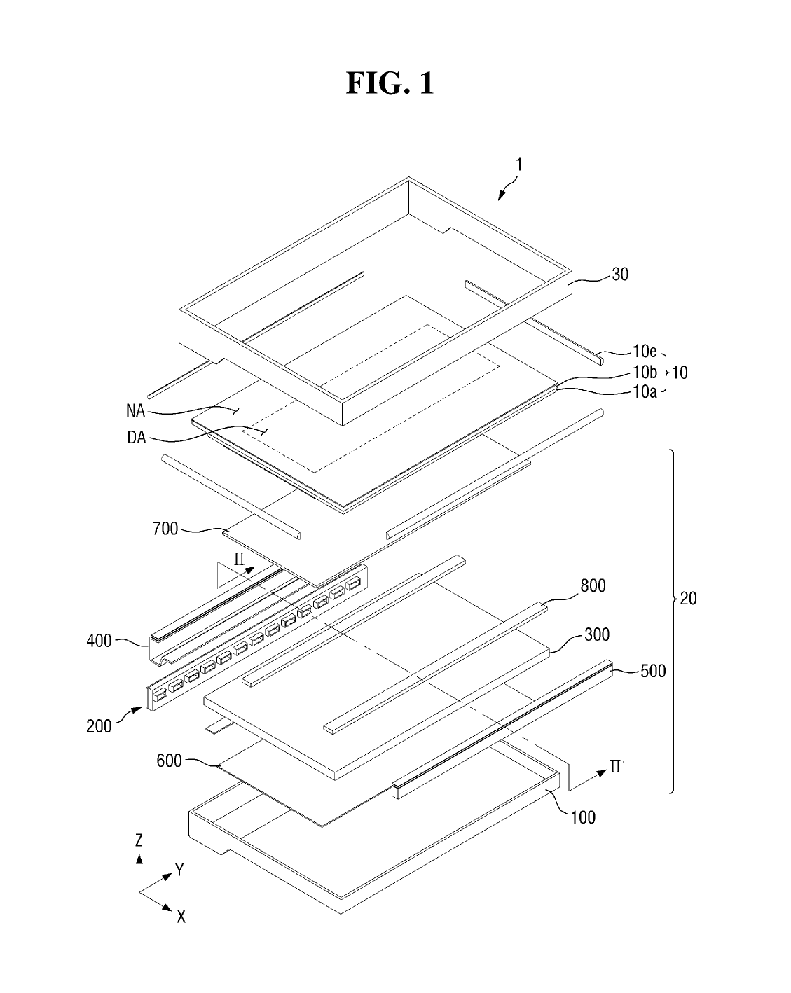

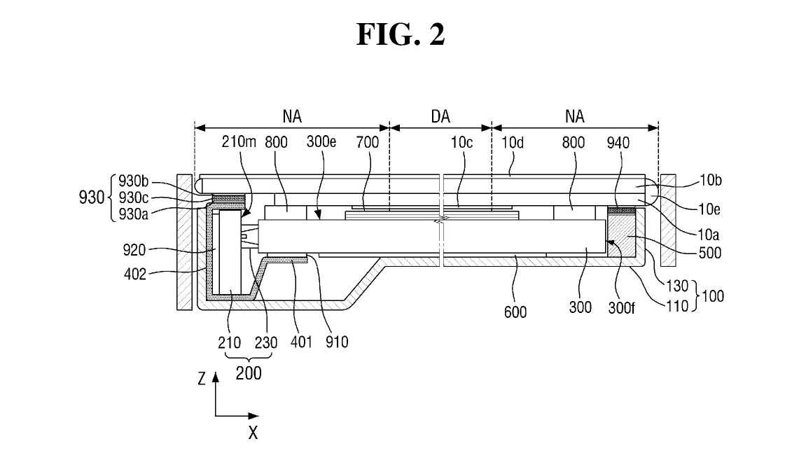

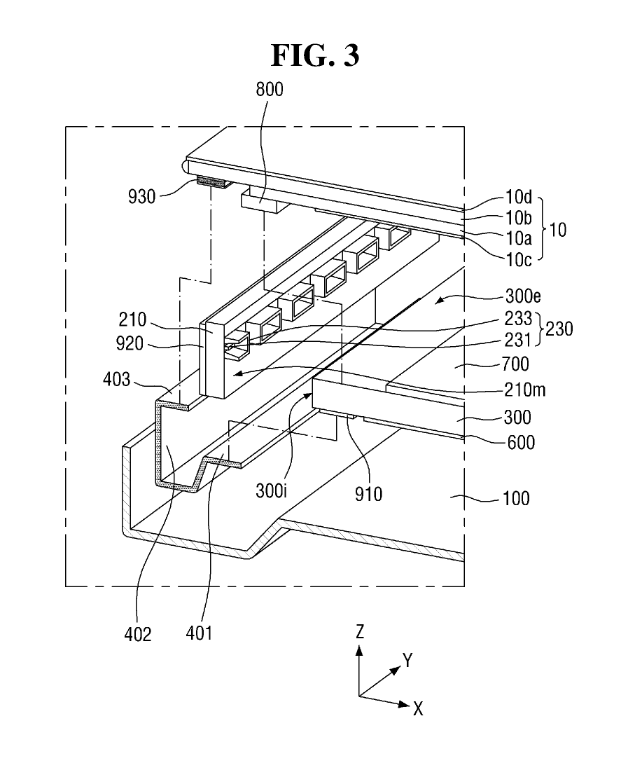

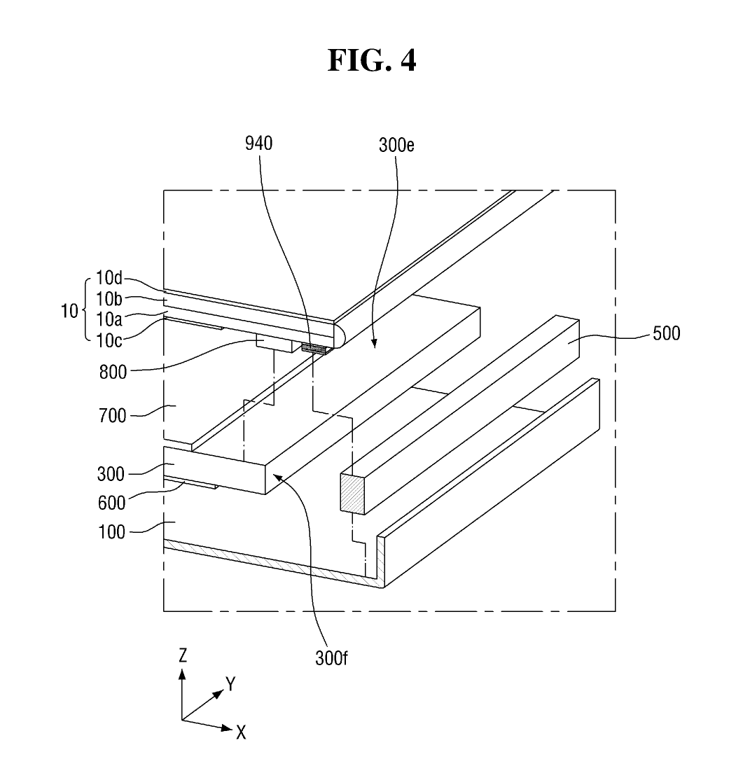

FIG. 1 is an exploded perspective view of a display device according to an embodiment of the present invention, FIG. 2 is a sectional view taken along the line II-II′ of FIG. 1, FIG. 3 is a sectional perspective view showing the vicinity of a holder of FIG. 2, and FIG. 4 is a sectional perspective view showing the vicinity of a middle mold of FIG. 2.

Referring to FIGS. 1 to 4, a display device 1 according to this embodiment may include a display panel 10, a backlight unit 20, and a top chassis 30.

The display panel 10 may be a panel including elements for realizing image display. Hereinafter, there will be exemplified a case where each of the display device 1 and the display panel 10 has an approximately rectangular shape including a pair of long sides and a pair of short sides in a plan view, but the present invention is not limited thereto. Each of the display device 1 and the display panel 10 may have a square shape, another polygonal shape, or a shape whose vertices are chamfered by one or more lines or curves.

A display area DA and a non-display area NA may be defined in the display panel 10. The display area DA is an area including a plurality of pixels and contributing to substantial image display by expressing different images for each pixel. In this specification, the “pixel” means a single area defined by dividing the display area DA for color display in a plan view, and one pixel represents a minimum unit capable of independently expressing colors. That is, each of the pixels may uniquely display one of the basic colors in order to realize color display. Examples of the basic colors include red, green and blue, but the present invention is not limited thereto.

In a plan view, the display area DA may be surrounded by the non-display area NA. The non-display area NDA may be an area in which the components necessary for the operation of the display panel 10 or the display device 1 are arranged and which does not substantially contribute to image display.

In an exemplary embodiment, the display panel 10 may be a liquid crystal display panel including a lower substrate 10a, an upper substrate 10b facing the lower substrate 10a, and a liquid crystal layer interposed therebetween. However, the present invention is not limited thereto, and another kind of display panel requiring a backlight unit 20 for displaying an image may also be applied. The display panel 10 may further include a lower polarizing layer 10c, an upper polarizing layer 10d, and a side cushion member 10e. The lower polarizing layer 10c and the upper polarizing layer 10d can perform an optical shutter function together with a liquid crystal layer disposed therebetween. The side cushion member 10e can prevent interference from occurring between the display panel 10 and the top chassis 30 due to an external force such as distortion of the backlight unit 20 or an external impact. Further, the lower substrate 10a and the upper substrate 10b may be in a state of being attached together by a sealing member such as a sealant.

The upper substrate 10b may have a larger planar area than the lower substrate 10a. For example, the side surface of the upper substrate 10b may further protrude compared to a side surface of the lower substrate 10a. In an exemplary embodiment, the lower substrate 10a may be a color conversion substrate including a color conversion pattern such as a color filter pattern, a quantum dot filter pattern, or a phosphor filter pattern, disposed for each pixel, and the upper substrate 10b may be a thin film transistor substrate including a plurality of switching elements and pixel electrodes, arranged for each pixel. A display panel driving unit necessary for driving the switching elements may be disposed on a part of the upper substrate 10b which does not overlap the lower substrate 10a.

Next, the backlight unit 20 will be described.

The backlight unit 20 may provide light having a specific wavelength to the display panel 10. The backlight unit 20 may be disposed under the display panel 10 to overlap the display panel 10 in the third direction Z.

In an exemplary embodiment, the backlight unit 20 may include a bottom chassis 100, a light emitting unit 200 and a light guide plate 300 accommodated in the bottom chassis 100, and a holder 400 holding the light emitting unit 200 and the light guide plate 300, and may further include a middle mold 500.

The bottom chassis 100 may be a housing member of the backlight unit 20 including the light emitting unit. The bottom chassis 100 may provide an inner space in which the light emitting unit 200 and the light guide plate 300 can be accommodated. For example, the bottom chassis 100 may have an approximately box shape including a bottom portion 110 and a side wall portion 130 protruding upward from an edge of the bottom portion 110. In a plan view, the bottom portion 110 of the bottom chassis 100 may have a shape corresponding to the display panel 10. The bottom portion 110 and side wall portion 130 of the bottom chassis 100 may be integrally formed without any physical boundary, or may be separately fabricated and then assembled together. The thickness of the bottom portion 110 and the thickness of the side wall portion 130 may be substantially uniform.

The bottom chassis 100 may be made of a material having high rigidity [N/m] and excellent thermal conductivity. For example, the bottom chassis 100 may be made of a metal material such as iron or stainless steel. As a non-limiting example, the bottom chassis 100 may be made of an alloy of nickel and/or chromium and iron. In some embodiments, the bottom chassis 100 may have a plated or coated surface.

Since the bottom chassis 100 is made of a material having high rigidity, the thickness of the bottom chassis 100 itself can be reduced or minimized. For example, the rigidity of the bottom chassis 100 is about 300 N/m or more, about 310 N/m or more, about 320 N/m or more, or about 330 N/m or more, and the maximum thickness of the bottom chassis may be about 0.8 millimeters (mm) or less, about 0.7 mm or less, about 0.6 mm or less, about 0.5 mm or less, about 0.4 mm or less, or about 0.3 mm or less. The lower limit of the maximum thickness of the bottom chassis 100 is not particularly limited, but may be about 0.01 mm or more from the viewpoint of durability of the backlight unit 20. Further, because the bottom chassis 100 is made of a material having excellent thermal conductivity, the heat generated from the light emitting unit 200 can be efficiently dispersed and discharged.

In another embodiment, the components in the backlight unit 20 are coupled and integrated with each other, and thus the bottom chassis 100 may be omitted.

The light emitting unit 200 may be disposed on the bottom portion 110 of the bottom chassis 100. The bottom portion 110 of the bottom chassis 100 has a partially recessed shape, and the light emitting unit 200 relatively long in the third direction Z is disposed in the recessed portion, thereby reducing the average thickness of the backlight unit 20. The light emitting unit 200 may be located at the long side of the display panel 10, but the present invention is not limited thereto.

In an exemplary embodiment, the light emitting unit 200 may be a light emitting diode unit. The light emitting unit 200 may include a light source circuit board 210 and a light source 230 disposed on one surface (right surface of FIG. 2) of the light source circuit board 210.

The light source circuit board 210 may provide a signal and power for driving the light sources 230, and may provide a space for mounting the light sources 230. For example, the light source circuit board 210 may be a printed circuit board. The light source circuit board 210 may extend in the second direction Y. The width of the light source circuit board 210 in the third direction Z may be larger than the thickness of the light source circuit board 210 in the first direction X.

One surface (right surface of FIG. 2) of the light source circuit board 210, on which the light source is disposed, defines a light source mounting surface 210m. A conductive pattern such as a pad and/or a lead for electrically connecting with the light source 230 may be formed on the mounting surface 210m of the light source circuit board 210.

In an exemplary embodiment, the mounting surface 210m of the light source circuit board 210 may be partially exposed. That is, the mounting surface 210m may be exposed to air or the like without being completely covered. The exposed area of the mounting surface 210m may be about 50 percent (%) or more, about 60% or more, about 70% or more, about 80% or more, or about 90% or more of the planar overall area of the mounting surface 210m. Since the exposed area of the mounting surface 210m is sufficiently secured, the heat generated from the light emitting diode chip 231 of the light source 230 can be effectively discharged through the exposed surface of the light source circuit board 210.

The light source 230 may be disposed on one surface (that is, mounting surface 210m) of the light source circuit board 210. In an exemplary embodiment, the light source 230 may be a light emitting diode package. The plurality of light sources 230 may be spaced apart from each other along the extension direction (second direction Y) of the light source circuit board 210.

One light source 230 may include a light emitting diode chip 231 and a light source mold 233 surrounding the light emitting diode chip 231.

The light emitting diode chip 231 may be a component that is electrically connected to the light source circuit board 210 and directly emits light. The light emitting diode chip 231 may emit white light, may emit blue light, or may emit light of an ultraviolet wavelength band. Although not shown in the drawing, a heat radiation structure may be formed between the light emitting diode chip 231 and the light source circuit board 210, thereby efficiently discharging the heat generated from the light emitting diode chip 231 through the light source circuit board 210.

The light source mold 233 may be disposed on the mounting surface 210m of the light source circuit board 210 to surround the light emitting diode chip 231. The light source mold 233 may provide a path of light emitted from the light emitting diode chip 231. For example, the light source mold 233 may have an opening overlapping the light emitting diode chip 231. The light emitted from the light emitting diode chip 231 may be discharged through the opening. The direction of the light emitted from the light source 230 defines a light exit surface of the light source 230. In an exemplary embodiment, the light source 230 may emit light through a right surface (that is, light exit surface) of FIG. 2. In this case, the light emitting unit 200 may be a top view type light emitting unit where the mounting surface 210m of the light source circuit board 210 is substantially parallel with the light exit surface of the light source 230. When the top view type light emitting unit 200, which has excellent heat radiation characteristics and allows the light emitting diode chip 231 to exhibit sufficient luminance and lifetime characteristics compared to a side view type light emitting unit where the mounting surface 210m is substantially perpendicular to the light exit surface, the durability and display quality of the backlight unit 20 and the display device 1 can be improved.

In some embodiments, the opening formed by the light source mold 233 may be filled with a filler made of a resin material, or a cover member may be disposed at the light exit surface of the light source 230, so as to protect the light emitting diode chip 231.

The light guide plate 300 may be disposed on the bottom portion 110 of the bottom chassis 100. The light guide plate 300 may guide the light provided from the light emitting unit 200 and transmit this light toward the display panel. For example, one surface (left surface in FIG. 2) of the light guide plate 300, facing the light emitting unit 200, defines a light entrance surface 300i, and one surface (upper surface in FIG. 2) of the light guide plate 300, facing the display panel 10, defines a light exit surface 300e. Further, the other surface (right surface in FIG. 2) of the light guide plate 300, facing oppositely away from the light entrance surface of the light guide plate 300, is defined as a counter surface 300f.

In an exemplary embodiment, the light entrance surface 300i (left surface) of the light guide plate 300 and the light exit surface (right surface) of the light emitting unit 200 may be substantially parallel to each other. Further, the light entrance surface 300i of the light guide plate 300 and the light exit surface of the light emitting unit 200 may be in contact with each other. The light guide plate 300 is in direct contact with the light source 230 of the light emitting unit 200 without a separate junction member, an air layer, or the like being interposed therebetween, but the present invention is not limited thereto. Because the light guide plate 300 and the light source 230 are configured to be in contact with each other, the light loss occurring near the light entrance surface 300i of the light guide plate 300 can be reduced or minimized. Further, because the surface of the light guide plate 300 and the surface of the light source 230 are in direct contact with each other in parallel with each other, the position deformation due to external force can be reduced or minimized, and thus the defect that the optical axis between the light guide plate 300 and the light emitting unit 200 is distorted can be suppressed. Furthermore, the width occupied by the light emitting unit 200 can be reduced or minimized, so as to reduce or minimize the width of the non-display area NA, that is, the width of the bezel.

Further, since the top view type light emitting unit 200 where the mounting surface 210m of the light source circuit board 210 and the light entrance surface of the light guide plate 300 are substantially parallel to each other is disposed at the side surface of the light guide plate 300, a sufficient clearance can be secured between the light source circuit board 210 and the light guide plate 300. For example, referring to FIG. 2, the upper surface of the light source circuit board 210 may be located at a higher level than the upper surface (that is, light exit surface) of the light guide plate 300, and the lower surface of the light source circuit board 210 may be located at a lower level than the lower surface of the light guide plate 300.

The light guide plate 300 is not particularly limited as long as it is made of a material having high light transmittance and a refractive index such that it can guide the light provided from the light emitting unit 200 without light loss, but the present invention is not limited thereto. For example, the light guide plate 300 may be made of a polymer material such as polyethylene terephthalate or a glass material. In some embodiments, the upper surface 300e and/or lower surface of the light guide plate 300 may have a light exit pattern that can assist the exit of guided light.

The holder 400 may be disposed in the bottom chassis 100. The holder 400 may be coupled with the light emitting unit 200 and the light guide plate 300 to integrate them. In the present specification, the meaning that any two or more components are coupled with each other means that a relative position therebetween is substantially fixed via means capable of forming a coupling between the components, which includes a reversible coupling capable of repetitive coupling and release and an irreversible coupling incapable of release. Examples of the coupling means include a fitting coupling such as a hook structure, a clip structure, or the like, an adhesion coupling using an adhesive or the like, or a screw coupling using a screw or the like.

The backlight unit 20 according to the present embodiment can reduce or minimize the position deformation due to external force or the like by integrating the light emitting unit 200 and the light guide plate 300 through the holder 400, and thus the optical axis between the light guide plate 300 and the light emitting unit 200 is distorted, thereby preventing the occurrence of light loss or the deterioration of light utilization efficiency.

The holder 400 may be located in the inner space of the bottom chassis 100. That is, the holder 400 may be configured to have no portion protruding outside the bottom chassis 100. Thus, the bottom chassis 100 can be formed as the outermost housing of the backlight unit 20, and the kind and structure of components in the backlight unit 20 can be simplified, so as to improve the reliability and durability of the backlight unit 20 and the display device 1, realize a narrow bezel structure and allow the display device 1 to be thinner and lighter.

The holder 400 may have a bent shape including one or more bent portions and curved portions. The thickness of the holder 400 may be substantially uniform. The upper limit of the maximum thickness of the holder 400 may be about 0.3 mm, or about 0.2 mm, or about 0.1 mm, but the present invention is not limited thereto. The holder 400 may be made of a material having high rigidity and excellent thermal conductivity. For example, the holder 400 may be made of a metal material such as iron or stainless steel. As a non-limiting example, the holder 400 may be made of an alloy of nickel and/or chromium and iron. The rigidity of the holder 400 is about 300 N/m or more, about 310 N/m or more, about 320 N/m or more, or about 330 N/m or more. Since the holder 400 is made of a material having high rigidity, the coupling between the light emitting unit 200 and the light guide plate 300 can be made rigid, and the defect that the optical axis between the light guide plate 300 and the light emitting unit 200 is distorted can be suppressed. Further, since the holder 400 is made of a material having excellent thermal conductivity, the heat generated from the light emitting unit 200 can be efficiently dispersed and discharged.

In an exemplary embodiment, the holder 400 includes a first coupling portion 401 coupled with the light guide plate 300 and a second coupling portion 402 coupled with the light emitting unit 200, and may further include a panel support portion 403 providing a space for supporting the display panel 10.

The first coupling portion 401 of the holder 400 may form a coupling with the light guide plate 300. Further, the first coupling portion 401 of the holder 400 may partially cover one surface (lower surface in FIG. 2) of the light guide plate 300. For example, the light guide plate junction member 910 is interposed between the first coupling portion 401 of the holder 400 and the lower surface of the light guide plate 300, so that the holder 400 and the light guide plate 300 may be coupled. The light guide plate junction member 910 may have a shape that extends in a substantially straight line along a second direction Y. The light guide plate junction member 910 may be in direct contact with the holder 400 and the light guide plate 300. The light guide plate junction member 910 may be a junction layer such as an adhesive layer, or may be a double-sided tape, but the present invention is not limited thereto.

The first coupling portion 401 may extend outward. Since the lower surface of the light guide plate 300 and the lower surface of the light source circuit board 210 have different levels, the extended portion may have a partial inclination. In addition, the extended portion may contact the light source circuit board 210 to contribute to heat transfer, but the present invention is not limited thereto.

The second coupling portion 402 of the holder 400 may form a coupling with the light emitting unit 200. For example, the light emitting unit junction member 920 is interposed between the second coupling portion 402 of the holder 400 and one surface (lower surface in FIG. 2) of the light guide plate 300, so that the holder 400 and the light guide plate 300 may be coupled. The light emitting unit junction member 920 may have a shape that extends in a substantially straight line along a second direction Y. The light emitting unit junction member 920 may be in direct contact with the holder 400 and the light source circuit board 210 of the light emitting unit 200. The light emitting unit junction member 920 may be a junction layer such as an adhesive layer, or may be a double-sided tape, but the present invention is not limited thereto.

The upper end of the second coupling portion 402 may protrude inward to form the panel support portion 403. The panel support portion 403 may overlap the upper surface of the light source circuit board 210. The panel support portion 403 of the holder 400 may form a coupling with the display panel 10. For example, a first panel junction member 930 may be interposed between the panel support portion 403 of the holder 400 and the upper substrate 10b of the display panel 10 to couple the holder 400 and the display panel 10. That is, the first panel junction member 930 may be brought into contact with the upper substrate 10b not overlapping the lower substrate 10a to be coupled with the upper substrate 10b. The first panel junction member 930 may have a shape that extends in a substantially straight line along a second direction Y. The components in the backlight unit 20 can be simplified, and the thickness thereof can be reduced by coupling the backlight unit 20 and the display panel 10 using the holder 400. In another embodiment, the panel support portion 403 of the holder 400 may be omitted, and the upper surface of the light source circuit board 210 may be exposed.

In an exemplary embodiment, the first panel junction member 930 may be a double-sided tape. The first panel junction member 930 may include a first junction layer 930a, a second junction layer 930b, and a cushion layer 930c interposed therebetween. Each of the first junction layer 930a and the second junction layer 930b may be an adhesive layer. The first panel junction member 930 for supporting and coupling the display panel 10 is configured to include the cushion layer 930c capable of absorbing a set or predetermined impact so that it is possible to prevent the backlight unit 20 from being distorted and to prevent the display panel 10 from being damaged by an external force such as an external impact.

In some embodiments, the optical density of the first panel junction member 930 may be greater than the optical density of the light guide plate junction member 910. The first panel junction member 930 has relatively high optical density to block unintended light transmission in the non-display area NA. The light guide plate junction member 910 may have relatively low optical density to reduce or minimize the absorption of light traveling in the light guide plate 300 and improve the light utilization efficiency.

As described above, the holder 400 according to the present embodiment may have a shape surrounding and covering the lower surface of the light guide plate 300, the lower surface of the light source circuit board 210, the left surface of the light source circuit board 210, and the upper surface of the light source circuit board 210. The light emitting unit 200 can be formed in a state of being sandwiched by using the physical shape of the holder 400 itself, and the coupling between the holder 400 and the light emitting unit 200 can be further strengthened by using the physical shape of the holder 400 itself.

In an exemplary embodiment, a surface (facing oppositely away from the lower surface of the light guide plate 300 covered by the first coupling portion 401), that is, the upper surface 300e of the light guide plate 300, may not be covered by the holder 400. In other words, the upper surface 300e of the light guide plate 300 may not face the holder 400. Any one of the upper surface 300e of the light guide plate 300 and the lower surface thereof is disposed not to face the holder 400, so as to protect or prevent the light guide plate 300 from being damaged by the holder 400 made of a metal material in the process of manufacturing the backlight unit 20. Further, a spacing distance between the holder 400 and the lower substrate 10a of the display panel 10 overlapping the holder 400 in the first direction X can be secured, so as to prevent the display panel 10 from being damaged by the holder 400 made of a metal material.

Although not shown in the drawings, the holder 400 and the bottom chassis 100 may be coupled to each other. For example, the holder 400 and the bottom chassis 100 may be fitted together, attached to each other, or screwed together.

In an exemplary embodiment, the backlight unit 20 may further include a middle mold 500. The middle mold 500 may be located in the inner space of the bottom chassis 100. That is, the middle mold 500 may be configured to have no portion protruding outside the bottom chassis 100.

The middle mold 500 may be located on the counter surface 300f of the light guide plate 300. That is, the middle mold 500 may be located at and extend along the long side of the display panel 10 at a position opposite to the light emitting unit 200. FIG. 1 and the like illustrate a case where the middle mold 500 extends in the second direction Y. However, in another embodiment, the middle mold 500 may be further disposed at and extend along each of the pair of short sides of the display panel 10 to have a [ (or ⊏) shape. When the middle mold has a [ (or ⊏) shape, the respective portions of the middle mold 500 may be integrally formed without physical boundary with each other, or may be separately fabricated and then coupled together, or may be separated or spaced from each other.

The middle mold 500 may be made of a material having set or predetermined rigidity and excellent durability. For example, the middle mold 500 may be made of plastic such as polycarbonate, a non-metallic inorganic material, or a carbon fiber.

The middle mold 500 may have set or predetermined thickness in the third direction Z, and the upper surface of the middle mold 500 may provide a space for supporting the display panel 10. FIG. 2 and the like illustrates a case where the sectional shape of the middle mold 500 is a quadrangle, but the sectional shape of the middle mold 500 is not particularly limited as long as it can provide a space for stably supporting the display panel 10.

The middle mold 500 may overlap the display panel 10 in the third direction Z, and may form a coupling with the display panel 10. For example, the middle mold 500 and the display panel 10 may be coupled with each other by interposing a second panel junction member 940 between the middle mold 500 and the lower substrate 10a of the display panel 10. That is, the second panel junction member 940 is brought into contact with the lower substrate 10a to be coupled with the lower substrate 10a. The second panel junction member 940 may have a shape corresponding to the middle mold 500. The display panel 10 is supported and coupled by using the middle mold 500, thereby protecting or preventing the edge of the display panel 10 from sagging.

In an exemplary embodiment, the second panel junction member 940, like the first panel junction member 930, may be a double-sided tape including a cushion layer. Since the double-sided tape including the cushion layer has been described together with the first panel junction member 930, a duplicative description will not be provided again.

In an exemplary embodiment, the middle mold 500 and the bottom chassis 100 may be coupled to each other. For example, the middle mold 500 and the bottom chassis 100 may be fitted together, attached to each other, or screwed together.

In an exemplary embodiment, the backlight unit 20 may further include a reflective sheet 600, an optical sheet, and a back cushion member 800.

The reflective sheet 600 may be disposed on the bottom portion 110 of the bottom chassis 100. The bottom chassis 100 may be disposed between the light guide plate 300 and the bottom chassis 100 to reflect the light incident on the reflective sheet 600 and transmit the reflected light toward the display panel 10. For example, the light leaked from the light guide plate 300 downward or the light reflected by the optical sheet 700 is reflected again and is transmitted upward. Thus, it is possible to increase the utilization efficiency of the light provided from the light emitting unit 200 and to improve the luminance and display quality of the display device 1.

The reflective sheet 600 is not particularly limited as long as it is made of a material having high light reflectance. For example, the reflective sheet 600 may be made of a plastic material such as polyethylene terephthalate, or a metal material. In some embodiments, the reflective sheet 600 may have a surface coated with a metal such as titanium (Ti) or silver (Ag), or a metal oxide such as titanium oxide.

In an exemplary embodiment, the reflective sheet 600 may overlap the light guide plate junction member 910, and may be disposed to be spaced apart from the light guide plate junction member 910 and the holder 400 in the first direction X. When the light emitting unit 200, the holder 400, and the light guide plate 300, which are integrated with each other, are inserted after the reflective sheet 600 is disposed in the bottom chassis 100 in the process of manufacturing the backlight unit 20, the reflective sheet 600 and the holder 400 are spaced apart from each other, so that the warpage or wrinkling of the reflective sheet 600 can be blocked or prevented by the holder 400 and the like, and the light guide plate 300 disposed on the reflective sheet 600 can be stably placed.

In some embodiments, the reflective sheet 600 may be in contact with the bottom chassis 100 and the light guide plate 300. However, the present invention is not limited thereto, and a set or predetermined junction layer may be interposed between the reflective sheet 600 and the light guide plate 300, so that the reflective sheet 600 and the light guide plate 300 may be integrally coupled with each other.

The optical sheet 700 may be disposed on the light guide plate 300. The optical sheet 700 can improve the luminance and viewing angle characteristics of the display device 1 by modulating the path and/or polarization characteristic of the light traveling from the light guide plate 300 toward the display panel 10. In an exemplary embodiment, the optical sheet 700 may include at least one of a prism sheet, a light collecting sheet such as a lens sheet, a diffusing sheet, and a reflective polarizing sheet. FIG. 2 and the like illustrate a case where the optical sheet 700 includes three separate optical sheets, but the optical sheet 700 may be a single sheet, two sheets or four or more sheets, or a plurality of individual optical sheets may be integrally coupled with each other.

The optical sheet 700 may overlap the light guide plate 300 and the reflective sheet 600 in the third direction Z. Further, the optical sheet 700 may be in contact with the light guide plate 300 and may be spaced apart from the display panel 10. For example, the optical sheet 700 may be spaced apart from the lower polarizing layer 10c of the display panel 10 by a set or predetermined distance. The optical sheet 700 and the lower polarizing layer 10c are spaced apart from each other by a set or predetermined distance, thereby preventing the optical sheet 700 and the lower polarizing layer 10c from being damaged due to interference with each other.

The back cushion member 800 may be disposed on the light guide plate 300. The back cushion member 800 may have a shape extending in the second direction Y. Further, the back cushion member 800 may be disposed to be spaced apart from the optical sheet 700 and the holder 400 in the first direction X. In another embodiment, the back cushion member may surround the optical sheet 700 and may have a substantially rectangular band (or frame) shape including a pair of long sides and a pair of short sides.

The back cushion member 800 is disposed on the back surface of the display panel 10 to support the display panel 10 and to maintain a spacing distance between the optical sheet 700 and the lower polarizing layer 10c. Further, the back cushion member 800 capable of absorbing an impact is disposed on the back surface of the display panel, thereby protecting or preventing the backlight unit 20 from being distorted or damaged by an external force such as an external impact.

Next, the top chassis 30 will be described.

The top chassis 30 may be a housing member of the display device 1 including the display panel 10. The top chassis 30 may have a sidewall shape surrounding the display panel 10 and the backlight unit 20. In a plan view, the top chassis 30 may have a substantially rectangular band (or frame) shape including a pair of long sides and a pair of short sides. The two long sides and the two short sides may be integrally formed without any physical boundary, or may be separately fabricated and then assembled together. For example, any long side and any short side may be fitted together, screwed together, or coupled with each other by interposing a connection member. In another embodiment, the top chassis may be omitted.

Hereinafter, other embodiments of the present invention will be described. However, duplicative descriptions of the same or substantially the same components as those of the above-described embodiments are omitted, and this can be understood by those skilled in the art from the attached drawings.

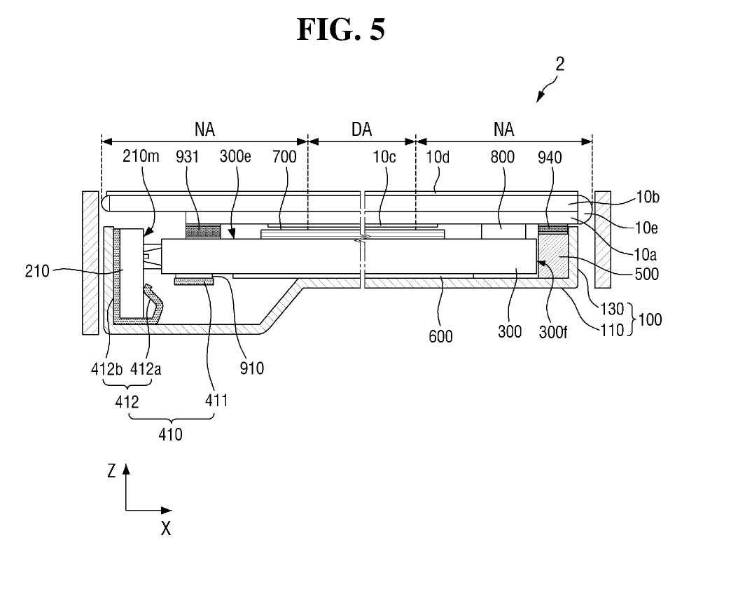

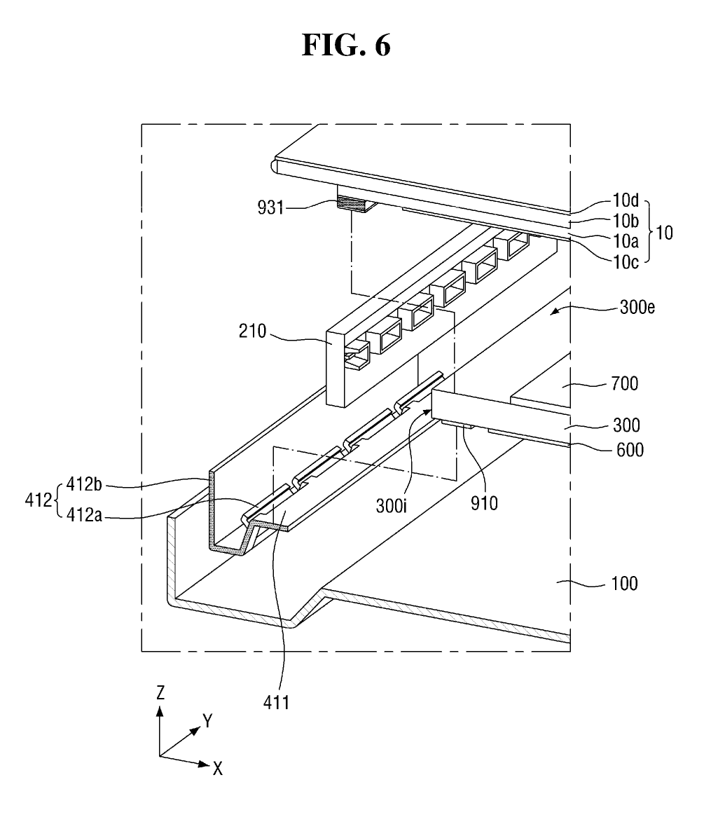

FIG. 5 is a sectional view of a display device according to another embodiment of the present invention. FIG. 6 is a sectional perspective view showing the vicinity of the holder of FIG. 5.

Referring to FIGS. 5 and 6, a display device 2 according to this embodiment is different from the display device 1 according to the embodiment with reference to FIG. 1 and the like in that a holder 410 and a light emitting unit 200 are fitted together.

In an exemplary embodiment, the holder 410 includes a first coupling portion 411 coupled with the light guide plate 300 and a second coupling portion 412 coupled with the light emitting unit 200. The second coupling portion 412 includes a fitting coupling portion structure 412a and 412b, for example, a clip structure.

For example, the second coupling portion 412 may include a protrusion portion 412a partially protruding and a side wall portion 412b disposed between the light source circuit board 210 and the bottom chassis 100. The protrusion portion 412a and the side wall portion 412b together may form a clip structure 412a and 412b. The light source circuit board 210 of the light emitting unit 200 may be fixed between the protrusion portion 412a and the side wall portion 412b in a state of being inserted therebetween.

The holder 410 according to the present embodiment may be coupled with the light emitting unit 200 without using a separate junction member. When the second coupling portion 412 has a fitting coupling structure as in this embodiment, the coupling between the holder 410 and the light emitting unit 200 can be released if necessary. Further, since the junction member may be omitted, the direct contact area between the holder 410 and the light source circuit board 210 can be increased, and the heat generated from the light source 230 can be effectively discharged through the light source circuit board 210, the holder 410, and the bottom chassis 100.

The holder 410 may not have a separate panel support portion. In this case, a first panel junction member 931 is interposed between the light guide plate 300 and the lower substrate 10a of the display panel 10 to couple the light guide plate 300 and the display panel 10 together. However, the present invention is not limited thereto, and, in another embodiment, the holder 410 may further include a panel support portion providing a space for supporting the display panel 10, and may be coupled with the display panel 10 by disposing a panel junction member on the panel support portion.

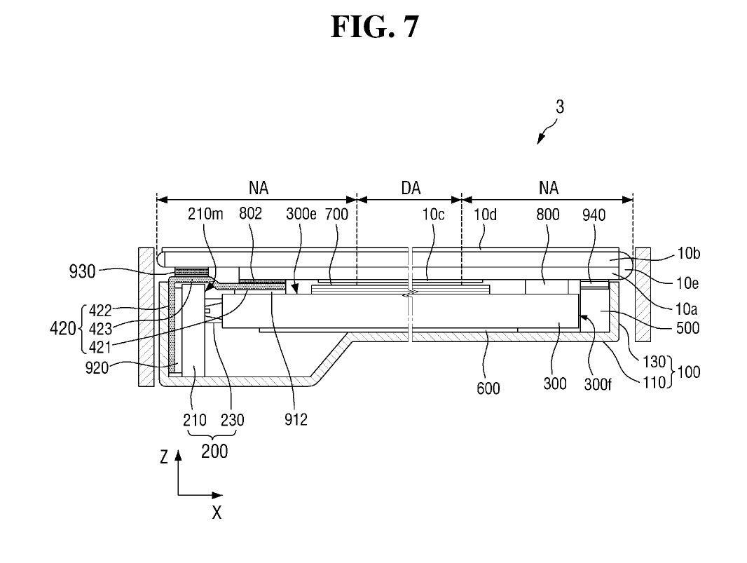

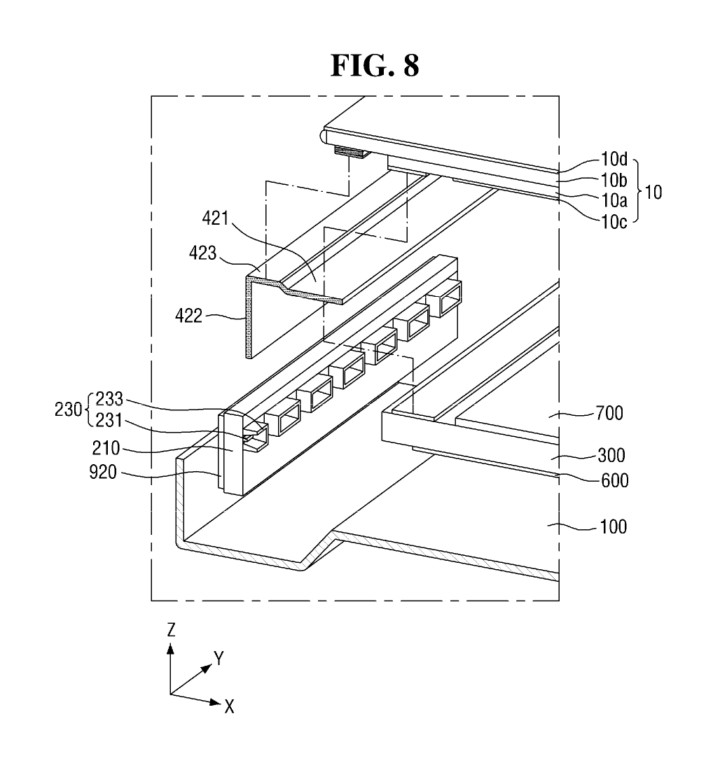

FIG. 7 is a sectional view of a display device according to still another embodiment of the present invention. FIG. 8 is a sectional perspective view showing the vicinity of the holder of FIG. 7.

Referring to FIGS. 7 and 8, a display device 3 according to this embodiment is different from the display device 1 according to the embodiment with reference to FIG. 1 and the like in that a holder 420 forms a coupling with the light exit surface 300e (upper surface) of the light guide plate 300.

In an exemplary embodiment, the holder 420 may include a first coupling portion 421 coupled with the light guide plate 300, a second coupling portion 422 coupled with the light emitting unit 200, and a panel support portion 423 providing a spacer for supporting the display panel 10.

The first coupling portion 421 of the holder 420 may form a coupling with the light guide plate 300. Further, the first coupling portion 421 of the holder 420 may partially cover one surface of the light guide plate 300 (upper surface in FIG. 7). For example, a light guide plate junction member 912 is interposed between the first coupling portion 421 of the holder 420 and the upper surface 300e of the light guide plate 300 to couple the holder 420 and the light guide plate 300 together.

Further, the first coupling portion 421 may extend outward. Since the upper surface 300e of the light guide plate 300 and the upper surface of the light source circuit board 210 have different levels, the extended portion may have a partial inclination. The portion protruding toward the outside of the first coupling portion 421 may form the panel support portion 423. The panel support portion 423 may overlap the upper surface of the light source circuit board 210. The panel support portion 423 of the holder 420 may form a coupling with the display panel 10.

Further, the edge of the panel support portion 423 may extend downward. The portion extending downward may form the second coupling portion 422. The second coupling portion 422 of the holder 420 may form a coupling with the light emitting unit 200.

As described above, the holder 420 according to this embodiment may have a shape surrounding and covering the upper surface 300e of the light guide plate 300, the upper surface of the light source circuit board 210, and the left surface of the light source circuit board 210. FIG. 7 and the like illustrate a case where the lower surface of the light source circuit board 210 is in contact with the bottom chassis 100 without being covered by the holder 420, but, in another embodiment, the second coupling portion 422 of the holder 420 may further extend to cover (or be under or below) the lower surface of the light source circuit board 210. In this case, the lower surface of the light source circuit board 210 may be in contact with the holder 420.

In an exemplary embodiment, a surface (facing oppositely away from the upper surface 300e of the light guide plate 300, covered by the first coupling portion 421), that is, the lower surface of the light guide plate 300 may not be covered by the holder 420. In other words, the lower surface of the light guide plate 300 may not face (or be opposed to) the holder 420. Thus, it is possible to prevent the light guide plate 300 from being damaged in the process of manufacturing the backlight unit. Further, the holder 420 is coupled with the upper surface 300e of the light guide plate 300, so that the reflective sheet 600 disposed on (or below) the lower surface of the light guide plate 300 can be further extended, and the light utilization efficiency can be improved. For example, the reflective sheet 600 may further extend toward the edge of the light guide plate 300 to partially overlap the first coupling portion 421 of the holder 420 and the light guide plate junction member 912.

The back cushion member 802 may be disposed between the first coupling portion 421 of the holder 420 and the display panel 10. In some embodiments, the optical density of the first panel junction member 930 and the back cushion member 802 may be greater than the optical density of the light guide plate junction member 912. The first panel junction member 930 and the back cushion member 802 have relatively high optical density to block unintended light transmission in the non-display area NA. The light guide plate junction member 912 may have relatively low optical density to reduce or minimize the absorption of light traveling in the light guide plate 300 and improve the light utilization efficiency.

As described above, according to the backlight unit and the display device including the backlight unit according to the embodiments of the present invention, the light emitting unit and the light guide plate are coupled with each other to integrate them (e.g., are integrated with each other by the holder to reinforce each other and is further reinforced by the holder), thereby suppressing the defect that the optical axis is distorted even when an external force is applied. Thus, the reliability and durability of the backlight unit can be improved, and the backlight unit can become thinner, and furthermore, the display quality of the display device can be improved.

The effects of the present invention are not limited by the foregoing, and other various effects are anticipated herein.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A display device, comprising:
a display panel; and
a backlight unit to provide light to the display panel,
wherein the backlight unit includes:
a light emitting unit to emit light,
a holder coupled with the light emitting unit and made of a metal material having rigidity, and
a light guide plate coupled with the holder and to guide light emitted from the light emitting unit, and
the light emitting unit and the light guide plate are integrated with each other by the holder.

2. The display device of claim 1,
wherein the holder includes:
a first coupling portion partially covering one surface of the light guide plate and coupled with the one surface, and
a second coupling portion coupled with a light source circuit board of the light emitting unit,
wherein a counter surface of the light guide plate, facing oppositely away from the one surface covered by the first coupling portion, is not covered by the holder.

3. The display device of claim 2,
wherein the backlight unit further includes a first junction member interposed between the first coupling portion of the holder and the light guide plate to couple the holder and the light guide plate,
the one surface is a lower surface of the light guide plate and the counter surface is an upper surface of the light guide plate,
the first coupling portion supports the lower surface of the light guide plate and is coupled with the lower surface thereof, and
the upper surface of the light guide plate is not covered by the holder.

4. The display device of claim 3,
wherein the holder further covers a lower surface of the light source circuit board and one side surface of the light source circuit board.

5. The display device of claim 3,
wherein the backlight unit further includes:
a reflective sheet disposed on the lower surface of the light guide plate and
a cushion member interposed between the upper surface of the light guide plate and the display panel, and
wherein the holder and the reflective sheet are disposed to be spaced apart from each other.

6. The display device of claim 2,
wherein the backlight unit further includes a first junction member interposed between the first coupling portion of the holder and the light guide plate to couple the holder and the light guide plate,
the one surface is an upper surface of the light guide plate and the counter surface is a lower surface of the light guide plate,
the first coupling portion is coupled with the upper surface of the light guide plate, and
the lower surface of the light guide plate is not covered by the holder.

7. The display device of claim 6,
wherein the holder further covers the upper surface of the light source circuit board and one side surface of the light source circuit board.

8. The display device of claim 6,
wherein the backlight unit further includes:
a reflective sheet disposed on the lower surface of the light guide plate, and
a cushion member interposed between the first coupling portion of the holder and the display panel,
the reflective sheet partially overlaps the first junction member, and
optical density of the cushion member is greater than optical density of the first junction member.

9. The display device of claim 2,
wherein the second coupling portion of the holder has a clip structure, and the light source circuit board of the light emitting unit is fitted into the clip structure.

10. The display device of claim 1,
wherein maximum thickness of the holder is about 0.3 millimeters (mm), or less, and rigidity of the holder is about 300 N/m, or more.

11. The display device of claim 1,
wherein the holder includes:
a first coupling portion partially covering one surface of the light guide plate and coupled with the one surface thereof,
a second coupling portion coupled with the light emitting unit, and
a support portion providing a space for supporting the display panel and coupled with the display panel.

12. The display device of claim 11,
wherein the light guide plate has a light entrance surface facing the light emitting unit and a light exit surface facing the display panel, and
the backlight unit further includes a middle mold disposed at a counter surface of the light guide plate, the counter surface facing oppositely away from the light entrance surface, the middle mold supporting the display panel and being coupled with the display panel.

13. The display device of claim 12,
wherein the backlight unit further includes:
a first junction member interposed between the first coupling portion of the holder and the light guide plate to couple the holder and the light guide plate, and
a second junction member interposed between the support portion of the holder and the display panel to couple the holder and the display panel or interposed between the middle mold and the display panel to couple the middle mold and the display panel, and
wherein optical density of the second junction member is greater than optical density of the first junction member.

14. The display device of claim 12,
wherein the backlight unit further includes a bottom chassis having an inner space for accommodating the light emitting unit, the holder, the light guide plate, and the middle mold,
the holder and the middle mold are disposed in the inner space of the bottom chassis,
the holder and the bottom chassis are coupled with each other, and
the middle mold and the bottom chassis are coupled with each other.

15. The display device of claim 12,
wherein the backlight unit further includes:
a bottom chassis accommodating the light emitting unit, the holder, the light guide plate and the middle mold;
a reflective sheet interposed between the bottom chassis and the light guide plate and in contact with the bottom chassis and the light guide plate; and
an optical sheet disposed between the light guide plate and the display panel and in contact with the light guide plate.

16. The display device of claim 1,
wherein the light emitting unit includes:
a light source circuit board and
a light source disposed on a mounting surface of the light source circuit board to emit light, and
the mounting surface of the light source circuit board is substantially in parallel with a light exit surface of the light source.

17. The display device of claim 16,
wherein an upper surface of the light source circuit board is located at a higher level than an upper surface of the light guide plate,
a lower surface of the light source circuit board is located at a lower level than a lower surface of the light guide plate, and
the light exit surface of the light source is in contact with a light entrance surface of the light guide plate.

18. The display device of claim 1,
wherein the display panel includes a lower substrate, an upper substrate facing the lower substrate, and a liquid crystal layer interposed between the lower substrate and the upper substrate,
a side surface of the upper substrate further protrudes out more than that of a side surface of the lower substrate, and
the upper substrate includes a plurality of switching elements disposed for each pixel.

19. The display device of claim 18,
wherein the backlight unit further includes a second junction member interposed between the holder and the display panel to couple the holder and the display panel, and
the second junction member is disposed to be in contact with the upper substrate.

20. A backlight unit, comprising:
a light emitting unit to emit light;
a holder coupled with the light emitting unit and made of a metal material having rigidity; and
a light guide plate coupled with the holder to guide light emitted from the light emitting unit,
wherein the light emitting unit and the light guide plate are integrated with each other by the holder.
